(19) United States
(12) Patent Application Publication
(10) Pub. No.: US 2025/0202363 A1
(43) Pub. Date: Jun. 19, 2025

(54) SWITCH CONVERTER AND METHOD OF CONVERTING A DC INPUT VOLTAGE INTO A DC OUTPUT VOLTAGE

(71) Applicant: Qorvo US, Inc., Greensboro, NC (US)

(72) Inventors: Van Liem Dinh, Hai Phong City (VN); Tommy Nguyen, Hanoi City (VN); Harry Trinh, Hanoi City (VN)

(21) Appl. No.: 18/414,876

(22) Filed: Jan. 17, 2024

(30) Foreign Application Priority Data
Dec. 19, 2023 (VN) 1-2023-09036

(51) Int. Cl. H02M 3/158; H02M 1/00; H02M 1/088; H02M 1/14

(52) U.S. Cl. CPC H02M 3/1582; H02M 1/0009; H02M 1/088; H02M 1/143

(57) ABSTRACT

Embodiments of a switch converter are disclosed. In some embodiments, a master switching stage includes a master primary switch, a master secondary switch, and a master power inductor. The primary master switch and the secondary master switch are opened and closed to generate a master ripple current from the Direct Current (DC) input voltage through the master power inductor. A slave switching stage includes a slave primary switch, a slave secondary switch, and a slave power inductor. The primary slave switch and the secondary slave switch are opened and closed to generate a slave ripple current from the DC input voltage through the slave power inductor, wherein a phase between the master ripple current and the slave ripple current is set in accordance with a ramp signal. The present disclosure also relates to a method of converting a DC input voltage into a DC output voltage.

### RELATED APPLICATIONS

This application claims priority to Vietnamese Patent Application No. VN 1-2023-09036, filed Dec. 19, 2023, the disclosure of which is hereby incorporated herein by reference in its entirety.

### FIELD OF THE DISCLOSURE

This disclosure relates generally to switch converters and methods of operating the same.

### BACKGROUND

Electronic system components such as microprocessors, central processing units (CPUs), graphics processing units (GPUs), application-specific integrated circuits (ASICs), and other digital integrated circuits and peripherals are growing increasingly complex. These components are demanding high power delivery requirements at higher and higher efficiency rates. Additionally, these components are demanding that power be delivered with greater power quality, such as having lower ripples in the current being delivered and better transient responses in order to minimize input and output capacitances presented to a source or a load. With such requirements, conventional switch converters are having trouble keeping pace with the increasing and more stringent power demands.

### SUMMARY

In some embodiments, a switch converter includes a master switching stage that includes a master primary switch, a master secondary switch, a master power inductor, and a master controller, wherein the master switching stage is operable to receive a direct current (DC) input voltage and wherein the master controller is configured to open and close the primary master switch and the secondary master switch to generate a master ripple current from the DC input voltage through the master power inductor, and generate a ramp signal based on the opening and closing of the primary master switch and the secondary master switch; and a slave switching stage that includes a slave primary switch, a slave secondary switch, a slave power inductor, and a slave controller, wherein the slave switching stage is operable to receive the DC input voltage and wherein the slave controller is configured to receive the ramp signal; open and close the primary slave switch and the secondary slave switch to generate a slave ripple current from the DC input voltage through the slave power inductor, wherein a phase between the master ripple current and the slave ripple current is set in accordance with the ramp signal. In some embodiments, the master power inductor and the slave power inductor are coupled to inject the master ripple current and the slave ripple current into an output node, wherein a DC output voltage is generated at the output node. In some embodiments, a power capacitor is coupled in shunt to the output node.

In some embodiments, a switch converter includes a master switching stage that includes a master primary switch, a master secondary switch, and a master power inductor, wherein the master switching stage is operable to receive a DC input voltage and wherein the master controller is configured to open and close the primary master switch and the secondary master switch to generate a master ripple current from the DC input voltage through the master power inductor, and generate a ramp signal based on the opening and closing of the primary master switch and the secondary master switch; and slave switching stages, wherein each of the slave switching stages is configured to receive the ramp signal, and generate a slave ripple current from the DC input voltage; wherein the slave switching stages are configured such that a phase of each of the slave ripple currents of the slave switching stages is set based on a different reference level of the ramp signal. In some embodiments, the master switching stage and the slave switching stages are coupled to inject the master ripple current and the slave ripple currents into an output node, and wherein a DC output voltage is generated at the output node. In some embodiments, a power capacitor is coupled in shunt to the output node.

A method of converting a DC input voltage into a DC output voltage, includes opening and closing a primary master switch and a secondary master switch to generate a master ripple current from the DC input voltage through a master power inductor; generating a ramp signal based on the opening and closing of the primary master switch and the secondary master switch; opening and closing a primary slave switch and a secondary slave switch to generate a slave ripple current from the DC input voltage through a slave power inductor, wherein a phase between the master ripple current and the slave ripple current is set in accordance with the ramp signal; and injecting the master ripple current and the slave ripple current into an output node such that the DC output voltage is generated at the output node.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1 is circuit diagram of a switch converter, in accordance with some embodiments.

FIG. 2 includes signal diagrams of the switch converter of FIG. 1, in accordance with some embodiments.

FIG. 3A is a circuit diagram of one embodiment of a master phase switching stage, in accordance with some embodiments.

FIG. 3B includes signal diagrams related to the master switching stage in FIG. 3A, in accordance with some embodiments.

FIG. 4 is a circuit diagram of the multi-phase controller, in accordance with some embodiments.

FIG. 5 is a circuit diagram of a current sensing circuit, in accordance with some embodiments.

FIG. 6 illustrates one embodiment of a loop current sensing circuit, in accordance with some embodiments.

FIG. 7 illustrates one embodiment of a DCR structure that applies another method to simplify the sensing current instead of using a loop current sense, in accordance with some embodiments.

FIG. 8A is a circuit diagram of one embodiment of a slave phase switching stage, in accordance with some embodiments.

FIG. 8B includes signal diagrams related to the slave switching stage in FIG. 8A, in accordance with some embodiments.

FIG. 9 is a flow diagram of a method of converting a direct current (DC) input voltage into a DC output voltage, in accordance with some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

Embodiments of a multiphase switch converter are disclosed herein. The switch converter has a master switching stage and one or more slave switching stages. The ripple current of the master switching stage is configured to have a designed phase difference with the ripple currents of the slave switching stages. During steady-state operation, individual phases for the ripple currents are intervals equal to 360°/N throughout the switching period where N is the total number of switching stages, in accordance with some embodiments. The arrangement is adaptive to changes in the time period of the master switching phase so that the slave switching phases match the time period and average current level of the master switching phase. The arrangement allows for lower capacitances to be provided at the input and output along with lower ripple currents to be generated.

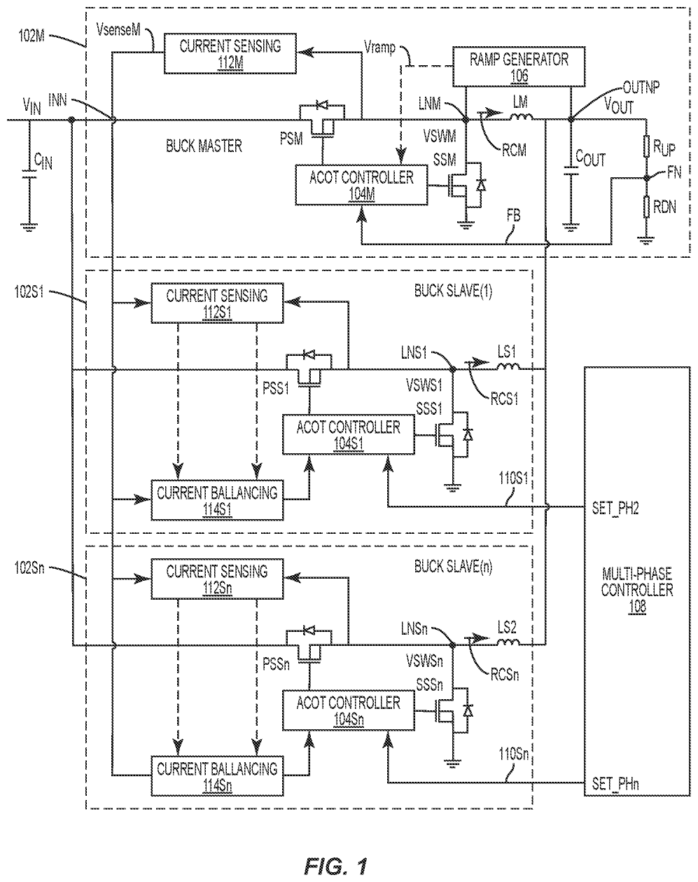

FIG. 1 is circuit diagram of a switch converter 100 in accordance with some embodiments.

The switch converter 100 is configured to receive a DC input voltage Vin and generate a DC output voltage Vout. The switch converter 100 includes a master switching stage 102M and slave switching stages 102S1-102Sn. Generically, the master switching stage 102M and the slave switching stages 102S1-102Sn are referred to as switching stages 102. Generically, the slave switching stages 102S1-102Sn are referred to as slave switching stages 102S. In FIG. 1, there are n number of slave switching stages 102S, where n is an integer greater than 1. In other embodiments, there is just one slave switching stage 102S1.

Throughout this discussion, when a reference indicator that includes a reference identifier followed by the letter M is used, the reference indicator is referring to a component of the master switching stage 102M. Throughout this discussion, when a reference indicator that includes a reference identifier followed by the letter S is used, the reference indicator is referring to a component of the slave switching stages 102S. Throughout this discussion, when a reference indicator that includes a reference identifier followed by the letter S1 is used, the reference indicator is referring to a component of the slave switching stage 102S1. Throughout this discussion, when a reference indicator that includes a reference identifier followed by the letter Sn, the reference indicator is referring to a component of the slave switching stage 102Sn. Throughout this discussion, a reference indicator that includes a reference identifier followed by the letter S followed by an integer is a reference indicator referring to a component of the slave switching stage 102S that is identified by the integer. For example, the reference indicator of 102S2 is referring to a slave switching stage 102S2. In this discussion, a generic indicator can be used with just a reference number. The discussion with the generic indicator is relevant to any component in the switching stages 102 having the component having the generic indicator followed by the specific indicator. For example, each of the switching stages 102 includes a power inductor L. A generic discussion of the power inductor L is relevant to the power inductor LM of the master switching stage 102M, an inductor LS1 of the slave switching stage 102S1, and the inductor LSn of the slave switching stage 102Sn. A discussion having the generic indicator followed by the letter S is relevant to any component in the slave switching stages 102S with the component having the generic indicator followed by the letter S and then followed by the specific indicator. A generic discussion of the power inductor LS is relevant to the power inductor LS1 of the slave switching stage 102S1, and the power inductor LSn of the slave switching stage 102Sn.

Referring again to FIG. 1, each of the switching stages 102 includes a primary switch PSM and a secondary switch SSM. Furthermore, an input to each of the switching stages 102 is connected to an input node INN, and an output of each of the switching stages 102 is connected to an output node OUTNP. The DC input voltage Vin is received at the input node INN. Thus, each of the switching stages 102 is configured to receive the DC input voltage Vin at the common input node INN. An input capacitor Cin is connected in shunt with respect to the input node INN. Thus, each of the switching stages 102 shares the same input capacitor Cin and the input node INN.

The DC output voltage Vout is generated at the output node OUTNP. An output capacitor Cout is connected in shunt with respect to the output node OUTNP. Thus, each of the switching stages 102 shares the same output capacitor Cout and the output node OUTNP.

In FIG. 1, each of the switching stages 102 is configured as a buck converter (i.e., step-down converter). In other embodiments, one or more of the switching stages are configured as a different type of converter, such as a boost converter, a buck-boost converter, and/or the like. Since each of the switching stages 102 is configured as a buck converter, the primary switch PS of each of the switching stages 102 is connected in series between the input node INN and an internal node LN. The node LN is internal to each of the switching stages 102. The secondary switch SS of each of the switching stages 102 is connected in shunt at the node LN. A power inductor L of each of the switching stages 102 is connected in series between the internal node LN and the output node OUTNP.

Each of the switching stages 102 includes an Adaptive Constant On-Time (ACOT) controller (referred to generically as ACOT controller 104 and specifically as ACOT controller 104M, 104S1, 104Sn). The ACOT controller 104 of each of the switching stages 102 is configured to open and close the primary switch PS and the secondary switch SS in order to generate a ripple current (referred to generically as ripple current RC and specifically as ripple current RCM, RCS1, RCSn). More specifically, the ACOT controller 104 of each of the switching stages 102 is configured to open and close the primary switch PS and the secondary switch SS in order to generate pulse width modulated (PWM) voltage (referred to generically as PWM voltage VSW and specifically as ripple current VSWM, VSW1, VSWn). In each of the switching stages 102 shown in FIG. 1, a positive edge of the PWM voltage VSW is generated in response to the ACOT controller 104 closing the primary switch PS and opening the secondary switch SS. While the primary switch PS is closed and the secondary switch SS is open, the DC input voltage Vin charges the output node OUTNP by powering the ripple current RC through the power inductor L. While the primary switch PS is closed and the secondary switch SS is open, the ripple current RC ramps up from a valley current level (a minimum current level) to a peak current level (a maximum current level).

A negative edge of the PWM voltage VSW is generated in response to the ACOT controller 104 opening the primary switch PS and closing the secondary switch SS. While the primary switch PS is open and the secondary switch SS is closed, the output node OUTNP is discharged, thereby reducing the ripple current RC. While the primary switch PS is opened and the secondary switch SS is closed, the ripple current RC ramps down from the peak current level to the valley current level.

However, the opening and closing of the primary switch PS and the secondary switches SS of the different switching stages 102 is performed such that the different ripple currents of each of the switching stages 102 have different phases. In some embodiments, the phase difference of the ripple currents RC that are adjacent to one another with respect to time is equal to 360/n (where n is the integer number of slave switching stages 102S), as explained in further detail below. To do this, the master switching stage 102M includes a ramp generator 106 that generates a ramp signal Vramp. In this example, a voltage level of the ramp signal Vramp tracks the current level of the master ripple current RCM. The ACOT controller 104M of the master switching stage 102M receives the ramp signal Vramp and compares the ramp signal Vramp with a valley reference voltage. In response to the ramp signal Vramp being below the valley reference voltage, the master primary switch PSM is closed and the master secondary switch SSM is opened. In response to the ramp signal Vramp being above a peak reference voltage, the master primary switch PSM is opened and the master secondary switch SSM is closed.

In some embodiments, the peak reference voltage is generated using a feedback signal FB that indicates a voltage level of the DC output voltage Vout. To do this, a voltage divider is connected to the output node OUTNP. The voltage divider includes a resistor RUP connected in series between the output node OUTNP and a node FN. The voltage divider also includes a resistor RDN connected between the node FN and a ground node configured to receive a ground voltage. The feedback signal FB is received by the ACOT controller 104M from the node FN.

Another ramp signal Vramp_PH is generated by the RC structure in multi-phase controller 108 based on the opening and the closing of the master primary switch PSM and the master secondary switch SSM. A multi-phase controller 108 is provided and is configured to generate the ramp signal Vramp PH. Within the multi-phase controller, different peak reference voltages are generated by holding the peak value of Vramp_PH and then dividing the peak value of Vramp_PH. As the ramp signal Vramp_PH goes above different ones of the peak reference voltages, the slave primary switch PSS of a different one of the slave switching stages 102S is closed and a slave secondary switch SSS is opened. This results in the slave ripple current RCS of the corresponding slave switching stages 102S ramping up. Once the ramp signal Vramp_PH goes above all of the peak reference voltages, the ramp signal Vramp_PH is ramped down by the closing of the master primary switch PSM and the opening of the master secondary switch SSM. Once the ramp signal Vramp_PH ramps down, the ramp signal Vramp_PH begins to ramp up again and the cycle begins again. The multi-phase controller 108 transmits a different set signal 110S1-110Sn to the different ACOT controllers 104S1-104Sn, where the set signals 110S1-110Sn indicate that the slave primary switch PSS of the corresponding slave switching stage 102S is to be closed and the slave secondary switch SSS is to be opened. When the slave primary switch PSS of the corresponding slave switching stage 102S is closed and the slave secondary switch SSS is opened by the corresponding ACOT controller 104S1-104Sn, the corresponding ripple current RCS of the slave switching stage 102S begins to ramp up from a valley current value.

Each of the switching stages 102 includes a current sensing circuit (referred to generically as current sensing circuit 112 and specifically as current sensing circuit 112M, 112S1-112Sn). Each of the current sensing circuits 112 is configured to sense a current level of the corresponding ripple current RC generated by the corresponding switching stage 102. In some embodiments, a peak current level of the ripple current RC is sensed by the current sensing circuit 112. In some embodiments, a valley current level of the ripple current RC is sensed by the current sensing circuit 112. In some embodiments, an average current level of the ripple current RC is sensed by the current sensing circuit 112.

Each of the slave switching stages 102S includes a current balancing circuit (referred to generically as current balancing circuit 114S and specifically as current balancing circuit 11481-114Sn). The current sensing circuit 112M of the master switching stage 102M is configured to generate a sensing voltage VsenseM having a voltage level that indicates a current level of the of the ripple current RCM. Each of the current balancing circuits 114S is then configured to receive a sensing voltage from a corresponding current sensing circuit 112S that indicates a current level of the corresponding ripple current RCS of the corresponding slave switching stage 102S. The current sensing circuit 112S causes the corresponding ACOT controller 104S to adjust the operation of the slave primary switch PSS and the slave secondary switch SSS so that the current level of the ripple current RCS for the correspond slave switching stage 102S is approximately equal to the current level of the ripple current RCM of the master switching stage 102M. Since the current levels of the switching stages 102 are balanced, over stress of the switching stages 102 (including the power inductor L of the switching stages 102) is avoided, in accordance with some embodiments.

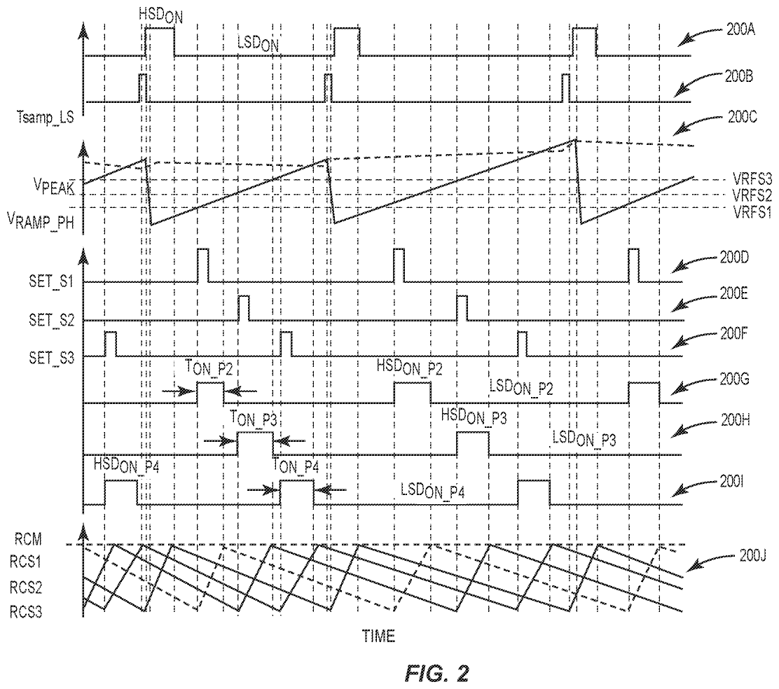

FIG. 2 includes signal diagrams 200A-200J of a switch converter, in accordance with some embodiments.

The domain of all of the signal diagrams 200A-200J is time. The signal diagrams 200A-200J assume that there are three slave switching stages (i.e., n=3) so that the switch converter 100 in FIG. 1 includes identical slave switching stages 102S1, 102S2, 102S3.

Signal diagram 200A illustrates a gate voltage for the master primary switch PSM generated by the ACOT controller 104M in the master switching stage 102M versus time, in accordance with some embodiments.

Signal diagram 200B illustrates a reference voltage control voltage Tsamp_LS generated by the ramp generator 106 in the master switching stage 102M versus time, in accordance with some embodiments.

Signal diagram 2000 illustrates the ramp voltage Vramp_PH and a reference voltage VPEAK versus time, in accordance with some embodiments.

Signal diagram 200D illustrates a set signal SET_S1 generated by the multiphase controller 108 and provided to the ACOT controller 104S1, in accordance with some embodiments.

Signal diagram 200E illustrates a set signal SET_S2 generated by the multiphase controller 108 and provided to the ACOT controller 104S2 (not explicitly shown in FIG. 1 but disclosed since it is assumed to equal n=3) of the slave switching stage 102S2 (not explicitly shown in FIG. 1 but disclosed since it is assumed to equal n=3), in accordance with some embodiments.

Signal diagram 200F illustrates a set signal SET_S3 generated by the multiphase controller 108 and provided to the ACOT controller 104S3 (corresponds to ACOT controller 104Sn in FIG. 1) of the slave switching stage 102S3 (corresponds to slave switching stage 102Sn in FIG. 1), in accordance with some embodiments.

Signal diagram 200G illustrates a gate voltage for the slave primary switch PS1 generated by the ACOT controller 104S1 in the slave switching stage 102S1 versus time, in accordance with some embodiments.

Signal diagram 200H illustrates a gate voltage for the slave primary switch PS2 (not explicitly shown in FIG. 1 but disclosed since it is assumed to equal n=3) generated by the ACOT controller 104S2 in the slave switching stage 102S2 versus time, in accordance with some embodiments.

Signal diagram 200I illustrates a gate voltage for the slave primary switch PS3 (correspond to slave primary switch PSn in FIG. 1) generated by the ACOT controller 104S3 in the slave switching stage 102S3 versus time, in accordance with some embodiments.

Signal diagram 200J illustrates ripple currents RCM (generated by the master switching stage 102M), RCS1 (generated by the slave switching stage 102S1), RCS2 (not explicitly shown in FIG. 1 but disclosed since it assumed that n=3), RCS3 (corresponds to RCSn in FIG. 1) versus time, in accordance with some embodiments.

In signal diagram 200J, each of the ripple currents RC are cyclical and oscillate from the same peak current level to the same valley current level. A phase difference between adjacent ripple current RC with respect to the time domain (e.g., ripple current RCM is adjacent to ripple current RCS3 with respect to the time domain, ripple current RC3 is adjacent to ripple current RC2 in the time domain, etc.) is approximately the same. The phase difference between the adjacent ripple currents RC is 360 degrees/n, and thus in this example, the phase difference is equal to 120 degrees.

For each of the gate voltages in signal diagrams 200A, 200G, 200H, and 200I, the primary switch PS is closed and the secondary switch SS is open when the gate voltages are in a high voltage state. For each of the gate voltages in signal diagrams 200A, 200G, 200H, and 200I, the primary switch PS is opened and the secondary switch SS is closed when the gate voltages in signal diagrams 200A, 200G, 200H, and 200I are in a low voltage state.

The ACOT controller 104M in the master switching stage 102M is configured to close the primary switch PSM and open the secondary switch, where the signal diagram 200A shows the gate voltage to the master primary switch PSM going from the low voltage state to the high voltage state. This causes the ripple current RCM shown in signal diagram 200J to ramp up from the valley current value. Additionally, this results in the control voltage Tsamp_LS to goes from the low voltage state to the high voltage state for short time. As explained in further detail below, once the control voltage Tsamp_LS is in the high voltage state, the reference voltage VPEAK is charged for a short duration until the control voltage Tsamp_LS to goes from the high voltage state to the low voltage state. Additionally, the ramp voltage Vramp_PH is ramped down from a peak voltage level to a valley voltage level. Once at the valley voltage level, the ramp voltage Vramp_PH begins to ramp up.

In response to the ripple current RCM reaching the peak current level, the gate voltage in signal diagram 200A goes from the high voltage state to the low voltage state. As a result, the ACOT controller 104M is configured to open the primary switch PSM and close the second switch SSM. Accordingly, the ripple current RCM begins to ramp down.

The multiphase controller 108 is configured to generate the set signal SET_S1 in a high voltage state, in response to the ramp voltage Vramp_PH being set above a reference voltage level VRFS1 (equal ¼ value of VPEAK). In response to the set signal SET_S1 in a high voltage state, the ACOT controller 104S1 closes the primary switch PSM and opens the secondary switch SSS1. As such, the gate voltage shown in the signal diagram 200G goes from the low voltage state to the high voltage state. Therefore, the ripple current RCS1 begins to ramp up from the valley current level.

The multiphase controller 108 is configured to generate the set signal SET_S2 in a high voltage state, in response to the ramp voltage Vramp_PH being set above a reference voltage level VRFS2 (equal ½ value of VPEAK). The reference voltage level VRFS2 is higher than the reference voltage level VRFS1. In response to the set signal SET_S2 in a high voltage state, the ACOT controller 104S2 closes the primary switch PSS2 and opens the secondary switch SSS2. As such, the gate voltage shown in the signal diagram 200H goes from the low voltage state to the high voltage state. Therefore, the ripple current RCS2 begins to ramp up from the valley current level.

The multiphase controller 108 is configured to generate the set signal SET_S3 in a high voltage state, in response to the ramp voltage Vramp_PH being set above a reference voltage level VRFS3 (equal ¾ value of VPEAK). The reference voltage level VRFS3 is higher than the reference voltage level VRFS2. In response to the set signal SET_S3 in a high voltage state, the ACOT controller 104S3 closes the primary switch PSS3 and opens the secondary switch SSS3. As such, the gate voltage shown in the signal diagram 200I goes from the low voltage state to the high voltage state. Therefore, the ripple current RCS3 begins to ramp up from the valley current level.

In response to the ripple current RCS1 reaching the peak current level, the gate voltage is set from the high voltage state to the low voltage state by the ACOT controller 104S1. In response, the primary switch PSS1 is opened and the secondary switch SSS1 is closed. As a result, the ripple current RCS1 is ramped down.

In response to the ripple current RCS2 reaching the peak current level, the gate voltage is set from the high voltage state to the low voltage state by the ACOT controller 104S2. In response, the primary switch PSS2 is opened and the secondary switch SSS2 is closed. As a result, the ripple current RCS2 is ramped down.

In response to the ripple current RCS3 reaching the peak current level, the gate voltage is set from the high voltage state to the low voltage state by the ACOT controller 104S3. In response, the primary switch PSS3 is opened and the secondary switch SSS3 is closed. As a result, the ripple current RCS3 is ramped down.

As shown by the signal diagram 200J, the switch converter 100 is not fixed frequency, but rather adjusts a period of each of the ripple currents RCM, RCS1, RCS2, RCS3 in accordance with a slope of the ripple currents RCM, RCS1, RCS2, RCS3. When the slope of the ripple currents RCM, RCS1, RCS2, RCS3 is slower, the period is longer and when the slope of the ripple currents RCM, RCS1, RCS2, RCS3 is faster, the period is shorter. By injecting current from multiple switching stages, the output ripple current at the output node OUTNP (from the peak current level to the valley current level) is reduced by a factor of 1/n+1. As a result, the output capacitance of the capacitor Cout can also be reduced by a factor of 1/n+1.

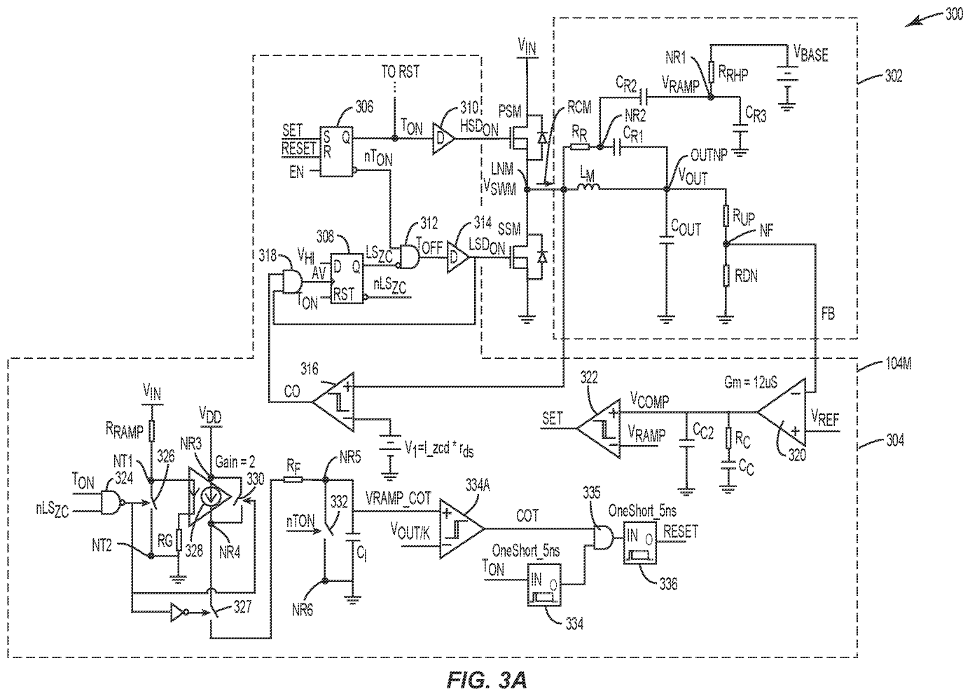

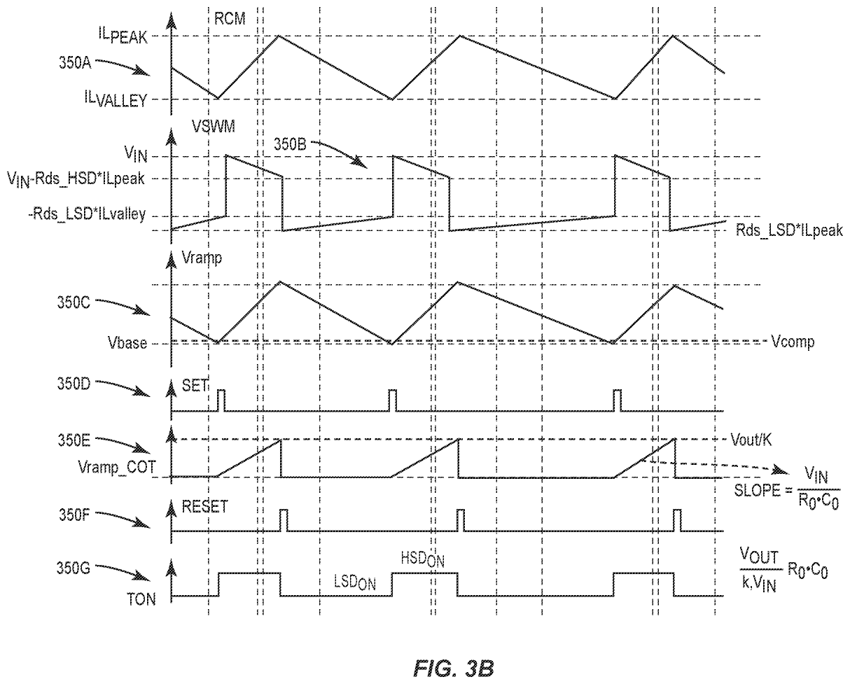

FIG. 3A is a circuit diagram of one embodiment of a master phase switching stage 300, in accordance with some embodiments. FIG. 3B includes signal diagrams related to the master switching stage 300.

The master switching stage 300 is an embodiment of the master switching stage 102M, in accordance with some embodiments. The master switching stage 300 includes an ACOT controller 304 and a ramp generator 302. The ACOT controller 304 is an embodiment of the ACOT controller 104M, in accordance with some embodiments. The ramp generator 302 is an embodiment of the ramp generator 106, in accordance with some embodiments. The master switching stage 300 does not explicitly show an embodiment of the current sensing circuit 112M of FIG. 1. Different embodiments of the current sensing circuit 112M are discussed below.

The master switching stage 300 includes the primary master switch PSM and the secondary master switch SSM, which were discussed above with respect to FIG. 1. In this embodiment, the primary master switch PSM is an N-channel field-effect transistor (NFET) and the second master switch SSM is an NFET. The primary master switch PSM receives the DC input voltage Vin at the drain terminal. A source terminal of the primary master switch PSM is connected to a drain terminal of the second master switch SSM. A source terminal of the second master switch SSM is connected to ground.

The ACOT controller 304 includes an SR latch 306. An S input terminal of the SR latch 306 is configured to receive a set signal SET and an R input terminal of the SR latch 306 is configured to receive a reset signal RESET. A clock terminal of the SR latch 306 is configured to receive an enable signal EN. An output voltage TON is generated by the SR latch 306 from a Q terminal of the SR latch 306. An output nTON (which is an inversion of the output TON) is generated by the SR latch 306 from a Qn terminal.

The ACOT controller 304 includes a D latch 308. A D input terminal of the D latch 308 is configured to receive a voltage VHI. The voltage VHI has a constant voltage level set to the power source voltage level of a power source voltage VDD. A clock terminal of the D latch 308 is configured to receive a trigger signal TON. An output voltage LSzc is generated by the D latch 308 from a Q terminal of the D latch 308. An output nLSzc (which is an inversion of the output LSzc) is generated by the D latch 308 from a Qn terminal.

A delay gate 310 has an input terminal that receives the output voltage TON generated by the SR latch 306 and generates an output voltage HSDON. The delay gate 310 has a designed propagation delay. Thus, the output voltage HSDON is a version of the output voltage TON that is delayed by the propagation delay of the delay gate 310. The output voltage HSDON is received by the gate of the primary master switch PSM.

An AND gate 312 has one input terminal that receives the voltage nTON and another input terminal that receives the voltage LSzc. The input terminal that receives the voltage LSzc inverts the voltage LSzc. The AND gate 312 is configured to generate a gate voltage LSDON that operates the low side master switch.

A delay gate 314 has an input terminal that receives the output voltage TOFF generated by the AND gate 312 and generates a gate voltage LSDON. The delay gate 314 has a designed propagation delay. Thus, the gate voltage LSDON is a version of the output voltage TOFF that is delayed by the propagation delay of the delay gate 314. The gate voltage LSDON is received by the gate of the secondary master switch SSM.

A voltage comparator 316 has a non-inverted terminal configured to receive the switches voltage VSWM from note LNM and an inverted terminal that is configured to receive a voltage V1. Voltage V1 has a small positive voltage reference level with a magnitude that is equal to I_zcd*rds. I_zcd*rds is a DC threshold level for a zero crossing detector. More specifically, I_zcd*rds is selected to be a small positive value. This ensures that lowside master secondary switch SSM can turn off when inductor current of the inductor LM reaches a current level OA and estimates the delay of comparator 316. The voltage comparator 316 is configured to generate an output voltage CO in a high voltage state in response to the ramp signal Vramp being higher than the voltage V1. The voltage comparator 316 is configured to generate the output voltage CO in a low voltage state in response to the ramp signal Vramp being lower than the voltage V1.

An AND gate 318 has one input terminal that receives output voltage CO and another input terminal that receives the voltage LSDON. The AND gate 318 is configured to generate an activation voltage AV. The activation voltage AV is configured to be received at the clock terminal of the D latch 308.

The ACOT controller 304 further includes an error amplifier 320. The error amplifier 320 includes an inverted terminal that is configured to receive the feedback signal FB from a node NF and a non-inverted terminal configured to receive a reference voltage VREF. The node NF is the node between the voltage divider with the resistors RUP and RDN. The output terminal of the error amplifier 320 is configured to generate an output voltage VCOMP. A series-connected resistor RC and a capacitor CC are connected in shunt with respect to the output terminal of the error amplifier 320. A capacitor CC2 is connected in shunt with respect to the output terminal of the error amplifier 320.

A fast voltage comparator 322 has a non-inverted terminal configured to receive the output voltage VCOMP and an inverted terminal that is configured to receive a voltage VRAMP. The fast voltage comparator 322 is configured to generate an output voltage SET in a high voltage state in response to the output voltage VCOMP being higher than the voltage VRAMP. The voltage comparator 322 is configured to generate the output voltage SET in a low voltage state in response to the output voltage VCOMP being lower than the voltage VRAMP.

A NAND gate 324 has one input terminal that receives signal TON and another input terminal that receives the voltage nLSzc. The NAND gate 324 is configured to generate output voltage that opens and closes a switch 326.

A power source terminal is configured to receive the voltage VIN. A resistor Rramp is connected in series between the power source terminal and a node NT1. A switch 326 is connected in series between the node NT1 and a node NT2. The node NT2 is connected to ground.

A transconductance amplifier 328 has an input terminal connected to the node NR1 and another input terminal connected to a resistor RD. The resistor RD is connected in series between the input terminal of the transconductance amplifier 328 and the node NR2. A power source terminal is configured to receive the power source voltage VDD. A node NR3 is connected to the power source terminal that receives the power source voltage VDD. An output terminal of the transconductance amplifier 328 is connected to a node NR4. A switch 330 is connected in series in a bypass path (that bypasses the transconductance amplifier 328) between the node NR3 and the node NR4. A switch 327 is connected in series between the node NR4 and a first end of a resistor RF. A second end of the resistor RF is connected to a node NR5. A capacitor Ci is connected in series between the node NR5 and a node NR6. The node NR6 is connected to ground. A switch 332 is connected in series in a bypass path (that bypasses the capacitor Ci between the node NR5 and the node NR6.

A voltage comparator 334A has a non-inverted terminal that is connected to the node NR5. A voltage VRAMP_COT is generated at the node NR5 and is received by the non-inverted terminal that is connected to the node NR5. An inverted terminal of the voltage comparator 334A is configured to receive the DC output voltage Vout divided by a factor k. An output voltage COT is generated by the voltage comparator 334A. A oneshort generator 334 has a terminal that is configured to receive the signal TON that provides a narrow pulse. In this embodiment, the high voltage holding time of the narrow pulse at the terminal of the oneshort generator 334 is 5 ns. The oneshort generator terminal 334 is configured to generate a narrow pulse version of the signal TON that is kept on 5 ns.

An AND gate 335 has one input terminal that is configured to receive the output voltage VCOT. Another input terminal of the AND gate 335 is configured to output a reset signal. A oneshort generator 336 is configured to generate a narrow pulse version of the reset signal, which is the reset signal RESET.

In this embodiment, the ramp generator 106 includes a circuit network that generates the ramp voltage VRAMP. The ramp generator 106 includes a voltage source that generates a voltage VBASE. A resistor RRHP is connected in series so as to receive the voltage VBASE at one end and is connected to a node NR1 at the other end. In voltage diagram 3B, the voltage A capacitor CR2 is connected in series between the node NR1 and a node NR2. A capacitor CR3 is connected in shunt at the node NR1. A resistor RR is connected in series between the node NR2 and the non-inverting terminal of the voltage comparator 316. A capacitor CR1 is connected in series between the node NR2 and a node OUTNP.

Referring to FIG. 3A and FIG. 3B, FIG. 3B illustrates the operation of the ACOT controller 104M shown in FIG. 3A.

Signal diagram 350A illustrates the ripple current RCM generated across an inductor LM versus time, in accordance with some embodiments.

Signal diagram 350B illustrates the voltage VSWM at the node LNM, in accordance with some embodiments.

Signal diagram 350C illustrates the voltage VRAMP and the voltage VBASE versus time, in accordance with some embodiments.

Signal diagram 350D illustrates the voltage SET versus time, in accordance with some embodiments.

Signal diagram 350E illustrates the voltage Vramp_COT and the output voltage Vout divided by the factor k versus time, in accordance with some embodiments.

Signal diagram 350F illustrates the voltage RESET and the output voltage Vout divided by the factor k versus time, in accordance with some embodiments.

Signal diagram 350G illustrates the voltage TON versus time, in accordance with some embodiments. It should be noted that the voltage TOFF is complementary thus has a phase difference of 180 degrees with respect to TON.

A ripple current RCM generated across the inductor LM oscillates between a current value of ILpeak to a current value of ILvalley. The primary switch PSM is turned on in order for the ripple current RCM to ramp up from the IL valley. To do this, the feedback signal FB is received at the inverter terminal of the error amplifier 320. The difference between feedback signal FB and a reference voltage VREF is output at the output terminal of the error amplifier 320. The capacitor CC, resistor RC, and capacitor CC2 form a low-pass filter that results in the voltage VCOMP, which has a DC voltage level that indicates the current value ILvalley. As shown in voltage diagrams 350C and 350D, the set signal SET is switched from the low voltage state to the high voltage state so long as VRAMP is less than the voltage VCOMP. Assuming that the enable signal EN is in an active state and since the reset signal RESET is in the low voltage state, the SR latch 306 generates the signal TON in the high voltage state. Accordingly, after the propagation delay of the delay terminal 310, the signal HSDON is set to a high voltage state. In response, the primary master switch PSM is closed (i.e., turned on). As a result, the ripple current RSM begins to ramp up and the switching voltage VSWM transitions to its peak value. Once the voltage VRAMP is greater than the voltage VCOMP, both the voltage SET and the voltage RESET in the low voltage state. Thus, the primary master switch PSM remains on.

When the signal TON is in the high voltage state, the signal nTON is in the low voltage state. Accordingly, the AND gate 312 outputs the signal TOFF in the low voltage state. In response, the secondary master switch SSM is opened (i.e., turned off). So long as the signal TON remains in the high voltage state, the secondary master switch SSM remains open.

The switch 326 and the switch 330 are open due to the nLSzc voltage being in a high voltage state and signal SET toggle high (TON goes high) whereby the output voltage of the AND gate 324 is in a low voltage state. Furthermore, the switch 327 is closed. Thus, a voltage is generated at the input terminals of the transconductance amplifier 326 that is based on the resistances of the resistors RRAMP and RD. Since the switch 332 is open since nTON is in the low voltage state, a current is generated through the resistor RF (equal VIN/RRAMP*Gain) that charges the capacitor Ci. As a result, the voltage VRAMP_COT ramps up as shown in voltage diagram 300E in FIG. 3B. Eventually, the voltage VRAMP_COT reaches and is greater than the voltage VOUT/k, which corresponds to the ripple current RCM having reached the peak current value of ILpeak. In response, the comparator output voltage COT is output in the high voltage state. Since TON is in the high voltage state and the comparator output voltage COT is in the high voltage state, the signal RESET is output in the high voltage state. In response, the SR latch 306 is configured to output TON in the low voltage state and output nTON in the high voltage state.

In response, the primary master switch PSM is opened and the ripple current RCM begins to ramp down towards the current value ILvalley. Furthermore, the switches 326, 330 are closed and the switch 327 is opened. Furthermore, the switch 332 is closed. As such, the node NR5 is shorted to ground causing the capacitor Ci to be discharged. Consequently, the voltage VRAMP_COT goes to ground and the signal RESET goes back to the low voltage state.

However, the SR latch 306 has now latched so that TON is in the low voltage state and that nTON is in the high voltage state. The reset terminal RST of the D latch 308 is configured to receive TON. In response to the output TON being in the low voltage state, the D latch 308 receives the low voltage state at the reset terminal RST and is configured to output LSZC in the low voltage state. The inverted terminal of the AND gate 312 is thus configured to receive the inversion of LSZC, which is in the high voltage state. Accordingly, both of the input terminals of the AND gate 312 are now in the high voltage state. This results in the output TOFF of the AND gate 312 being in the high voltage state and thus the output LSDON of the delay gate 314 is in the high voltage state. Accordingly, the secondary master switch SSM is turned on in response to the LSDON being in the high voltage state.

Once the voltage VRAMP is above the voltage V1, the comparator 316 is configured to generate the comparator output CO in the high voltage state. As such both input terminals of the AND gate 818 are both in the high voltage state, since both LSDON state and the comparator output CO are in the high voltage state. In response, the output AV of the AND gate 318 is generated in the high voltage state, resulting in the D latch 308 receiving the high voltage state. The voltage VHI is a DC voltage in the high voltage state that is received at the D terminal of the D latch 308. Accordingly, in response to the output AV being in the high voltage state, the output LSZC of the D latch 308 is in the high voltage state. This results in the inverted terminal of the AND gate 312 receiving the low voltage state. In response, the output of the AND gate TOFF is in the low voltage state and, in response, the output LSDON of the delay gate 314 is in the low voltage state. This results in the master secondary switch SSM again being opened (i.e., turned off). The cycle thus can again begin and repeat itself in the next oscillation.

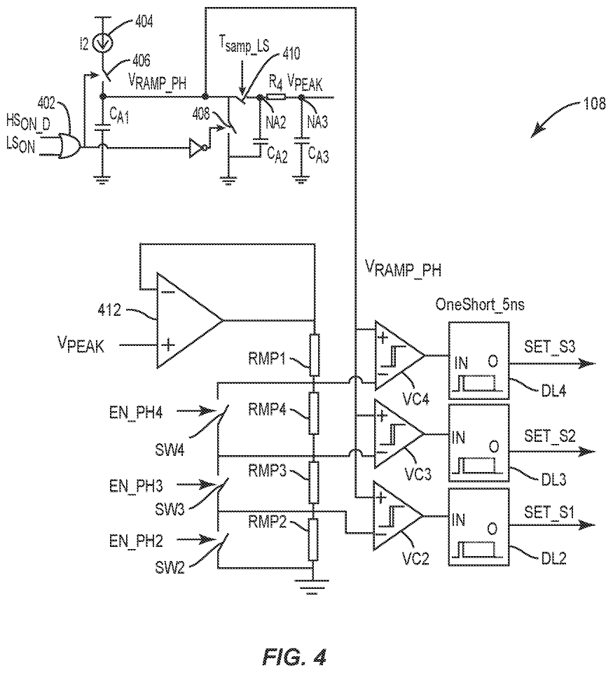

FIG. 4 is a circuit diagram of the multi-phase controller 108, in accordance with some embodiments.

As shown in FIG. 4, the multi-phase controller 108 also includes an OR gate 402, a current source 404, a switch 406, a switch 408, a switch 410, a capacitor CA1, a capacitor CA2, and a capacitor CA3. An input terminal of the OR gate 402 is configured to receive a voltage HSDON_D. The voltage HSDON_D is a delayed version of the voltage HSDON. The other input terminal of the OR gate 402 is configured to receive a voltage LSDON. The current source 404 is connected in series with the switch 406. The switch 406 is connected between the current source 404 and a node NA1. The capacitor CA1 is connected in shunt to the node NA1. The switch 408 is connected in shunt to the node NA1. The switch 410 is connected in series between the node NA1 and a node NA2. The capacitor CA2 is connected in shunt to the node NA2. A resistor R4 is connected between the node NA2 and a node NA3. The capacitor CA3 is connected in shunt to the node NA3.

In response to either HSDON_D or LSDON in the high voltage state, the switch 406 is closed and the switch 408 is open. In this case, a voltage VRAMP_PH is ramping up as the current source 404 is charging the capacitor CA1 (see voltage diagram 2000). In response to both HSDON_D or LSDON being in the low voltage state, the switch 406 is opened and the switch 408 is closed. As a result, the voltage VRAMP_PH ramps down since the capacitor CA1 is discharged. In response, the capacitor CA1 is discharged through the switch 408 and thus the voltage VRAMP_PH ramps down (see voltage diagram 2000). The switch 410 is opened and closed by the signal Tsamp_LS. The signal Tsamp_LS is in the high voltage state in response to the voltage VRAMP_PH being greater than the voltage VPEAK. When the signal Tsamp_LS is in the high voltage state, the switch 410 is closed and the voltage VPEAK is charged by the current source 404. The signal Tsamp_LS is in the low voltage state in response to the voltage VRAMP_PH being less than the voltage VPEAK. The switch 410 is open and thus the voltage VPEAK is not charged by the current source 404.

The multiphase controller 108 includes a voltage follower 412, a switch SW4, a switch SW3, a switch SW2, a voltage comparator VC4, a voltage comparator VC3, a voltage comparator VC2, a oneshort generator DL4, a oneshort generator DL3, a oneshort generator DL2, a resistor RMP4, a resistor RMP3, a resistor RMP2, and a resistor RMP1. The non-inverting terminal of each of the voltage comparators VC4, VC3, VC2 is configured to receive the ramp voltage VRAMP_PH generated by the ramp generator 106 (see FIG. 3A). The resistors RMP4, RMP3, RMP2, RMP1 all have the same resistance value. Furthermore, the oneshort generators DL4, DL3, DL2 each have the same high voltage stage holding time. In some embodiments, this value is designed by 5 ns.

The voltage follower 412 includes a non-inverting terminal that is configured to receive the voltage VPEAK and an inverting terminal that is connected as negative feedback with unity gain to the output terminal of the voltage follower 412. The output voltage of the voltage follower 412 is thus equal to VPEAK. The resistor RMP1 is connected in series between the output terminal of the voltage follower 412 and the inverting terminal of the voltage comparator VC4. The voltage level of the voltage at the inverting terminal of the voltage comparator VC4 is thus VRFS3 (see voltage diagram 2000 in FIG. 2). The resistor RMP4 is connected in series between the inverting terminal of the voltage comparator VC4 and the inverting terminal of the voltage comparator VC3. The voltage level of the voltage at the inverting terminal of the voltage comparator VC3 is thus VRFS2 (see voltage diagram 2000 in FIG. 2). The resistor RMP3 is connected in series between the inverting terminal of the voltage comparator VC3 and the inverting terminal of the voltage comparator VC2. The voltage level of the voltage at the inverting terminal of the voltage comparator VC2 is thus VRFS1 (see voltage diagram 2000 in FIG. 2). The resistor RMP2 is connected in series between the inverting terminal of the voltage comparator VC2 and ground. Opening and closing the switches SW4, SW3, SW2 determines the number of phases that are operable in the switch converter 100. To 360 degree phase is always provided since the master switching stage 102M is always provided.

To operate dual switching converters (a master and one slave switching converters) with 180 degree phase shifts between the switch converters, the phase enable signal EN_PH2 is set to a low voltage state, the switch SW2 is open, and both of the switches SW3, SW4 are closed in response to setting the enable signals EN_PH3, EN_PH4 to a high voltage state. The output of voltage comparator VC2 is transmitted through the oneshort generator DL2 to generate the narrow pulse phase signal SET_1. This configuration is used if the system in FIG. 1 includes one master converter 102M and the slave converter 102S2.

To operate triple switching converters (a master and two slave converters) with 90 degree phase shifts between each of the switch converters, both of the phase enable signals EN_PH2, EN_PH3 are set 0, the switches SW2, SW3 are open, and the switch SW4 is closed by setting EN_PH4=1. The output of voltage comparators VC2, VC3 are transmitted through the oneshort generator DL2, DL3 to generate the narrow pulse phase signal SET_1, SET_2. This configuration means the system in FIG. 1 operates the master converter 102M and the two slave converters 102S2 and 102S3.

To operate quarter switching converters (a master and three slave converters) with a 45 degree shift phase between each of the switch converters, all of the phase enable signals EN_PH2, 3, 4 are set to 0, SW2, 3, 4 are open. The output of voltage comparator VC2,3,4 are transmitted through the oneshort generator DL2,3,4 to generate the narrow pulse phase signal SET_S1,2,3. This configuration means that the system in FIG. 1 includes one master step-down converter 102M and three slave converter 102S2, 102S3, and 102S4.

The output of the voltage comparator VC4 is transmitted through the oneshort generator DL4 to generate the phase signal SET_S3. The output of the voltage comparator VC3 is transmitted through the oneshort generator DL3 to generate the phase signal SET_S2. The output of the voltage comparator VC2 is transmitted through the oneshort generator DL2 to generate the phase signal SET_S1.

By providing Vpeak through the voltage follower 412, a lower output impedance is presented to the voltage comparators VC4, VC3, VC2. The resistors RMP1, RMP2, RMP3, RMP4 divide the reference voltage VPEAK to present the reference voltage levels VRFS1, VRFS2, VRFS3 to the voltage comparators VC4, VC3, VC2, as explained above. Also as explained above, the reference voltage levels VRFS1, VRFS2, VRFS3 will be used to compare with the saw-tooth wave ramp voltage Vramp_PH to determine the phase shift for the slave switching stages 102S1, 102S2, 102S3 to start. As the result, the slave switching stages 102S1, 102S2, 102S3 have ripple currents RC where adjacent ripple currents in time are separated by 360DEG/n and operate at the same switching cycle as master switching stage 102M at the static operating conditions.

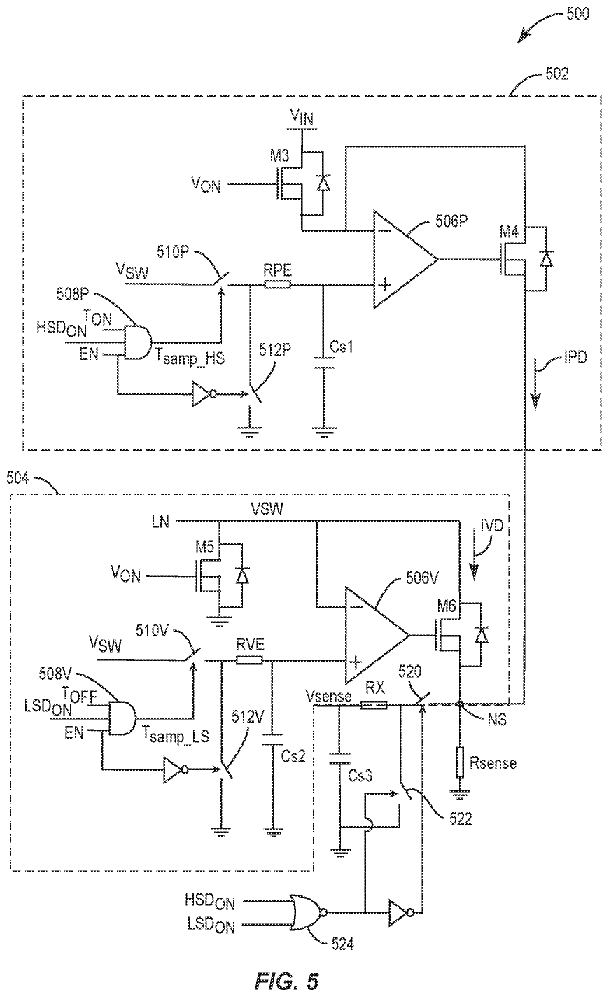

FIG. 5 is a circuit diagram of an average current sensing circuit 500, in accordance with some embodiments.

In some embodiments, some or each of the current sensing circuit 112M and the current sensing circuits 112S1-112Sn are provided in the same manner as the current sensing circuit 500.

The current sensing circuit 500 has a current peak detector 502 and a current valley detector 504. The current peak detector 502 generates a current IPD that is proportional to the current peak of the ripple current RC generated by the switching stage 102. The current valley detector 504 generates a current IVD that is proportional to the current valley of the ripple current RC generated by the switching stage 102.

The current peak detector 502 includes an operational amplifier 506P, an AND gate 508P, a resistor RPE, a capacitor CS1, a switch 510P, a switch 512P, an NFET M3, and an NFET M4. A switching voltage VSW is received by one end of the switch 510P while another end of the switch 510P is connected to a first end of the resistor RPE. The capacitor CS1 is connected in shunt to the second end of the resistor RPE and to the non-inverting terminal of the operational amplifier 506P. The AND gate 508P is configured to receive the signals TON, HSDON, and EN. In response to the signals TON, HSDON, and EN being in the high voltage state, the switch 510P is closed and the switch 512P is opened. Otherwise, the switch 510P is open and the switch 512P is closed. When the switch 510P is closed, the switching voltage VSW is received from the switching stage 102. The switching voltage VSW thus results in the capacitor being charged up. The voltage at the top of the capacitor CS1 is input into the non-inverting terminal of the operational amplifier 506P.

The drain of the NFET M3 is configured to receive the DC input voltage Vin. The gate of the NFET M3 is configured to receive the voltage VON, which maintains the NFET M3 turned on. The source of the NFET M3 is connected to the inverting terminal. The drain of the NFET M4 is connected to the inverting terminal of the operational amplifier 506P. The gate of the NFET M4 is connected to the output terminal of the operational amplifier 506P. The source of the NFET M4 is connected to a sense node NS. The NFET M3 and a primary switch PS of the switching stage 102 that generates the relevant ripple current RC have a transconductance ratio. Since the drain of the NFET M4 is connected to the inverting terminal of the operational amplifier 506P, this causes a feedback effect that results in the current level of the current IPD being proportional to the current peak of the ripple current RC. The current IPD is output to the sense node NS while the current peak detector 502 is activated.

The current valley detector 504 includes an operational amplifier 506V, an AND gate 508V, resistor RVE, a capacitor CS3, a switch 510V, a switch 512V, an NFET M5, and an NFET M6. The switching voltage VSW is received by one end of the switch 510V while another end of the switch 510V is connected to a first end of the resistor RVE. A capacitor CS2 is connected in shunt to the second end of the resistor RVE and to the non-inverting terminal of the operational amplifier 506V. The AND gate 508V is configured to receive the signals TOFF, LSDON, and EN. In response to the signals TOFF, LSDON, and EN being in the high voltage state, the switch 510V is closed and the switch 512V is opened. Otherwise, the switch 510V is open and the switch 512V is closed. When the switch 510V is closed, the switching voltage VSW is received from the switching stage 102. The switching voltage VSW thus results in the capacitor being charged up. The voltage at the top of the capacitor CS2 is input into the non-inverting terminal of the operational amplifier 506V.

The drain of the NFET M5 is configured to receive the VSW voltage at note LN (FIG. 1). The gate of the NFET M5 is configured to receive the voltage VON, which maintains the NFET M5 turned on. The source of the NFET M5 is connected to the inverting terminal. The drain of the NFET M6 is connected to the inverting terminal of the operational amplifier 506V. The gate of the NFET M6 is connected to the output terminal of the operational amplifier 506V. The source of the NFET M6 is connected to the sense node NS. The NFET M5 and the secondary switch SS of the switching stage 102 that generates the relevant ripple current RC have a transconductance ratio. Since the drain of the NFET M6 is connected to the inverting terminal of the operational amplifier 506V, this causes a feedback effect that results in the current level of the current IVD being proportional to the current valley of the ripple current RC. The current IVD is output to the sense node NS while the current valley detector 502 is activated.

The current sensing circuit 500 also includes a switch 520, a resistor RX, a switch 522, a resistor Rsense, the capacitor Cs3, and a NOR gate 524. The resistor Rsense is connected in shunt to the node NS. The switch 520 is connected in series between the node NS and a first end of the resistor RX. The switch 522 is connected in shunt to the first end of the resistor RX. The capacitor CS3 is connected in shunt to the second end of the resistor RX. The sense voltage Vsense is output from the second end of the resistor RX. The current IPD and the current IVD thus charge the capacitor CS3 to generate the voltage Vsense. Since the current IPD is proportional to the current level ILPEAK and since the current IVD is proportion to the valley current ILVALLEY, the voltage level of Vsense is proportional to the average current level of the ripple current. It should be noted that if the current sensing circuit 500 is used in the master switching stage 102M, the voltage Vsense is referred to as the voltage VsenseM that indicates the average ripple current RCM. If the current sensing circuit 500 is used in the master switching stage 102M, the voltage Vsense is referred to as the voltage VsenseS that indicates the average ripple current RCS of one of the slave switching stages 102S.

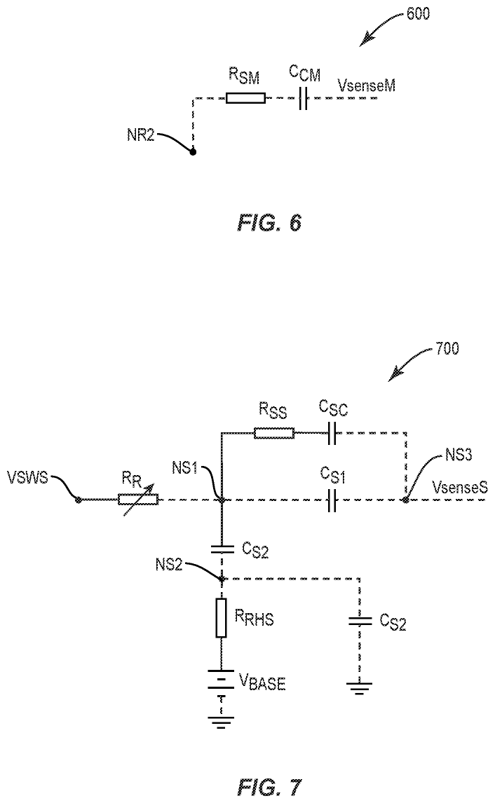

Referring now to FIG. 3A and FIG. 6, FIG. 6 illustrates one embodiment of a current sensing circuit 600, in accordance with some embodiments.

The current sensing circuit 600 is an example of the current sensing circuit 112M of the master switching stage 102M, in accordance with some embodiments. The current sensing circuit 600 includes a resistor RSM in series with a capacitor CCM. A first end of the resistor is connected to the node NR2 (See also FIG. 3A). A second end of the resistor RSM is configured to generate the voltage VsenseM having a voltage level that indicates an average current level of the ripple current RCM of the master switching stage 102M. The ripple current voltage RCM is received at the node NR2, through the resistor RSM.

The ACOT 104M does not operate as a fixed switching frequency regulator. The resistors RRHP, RR, and RSM and the capacitors CC, CR1, CR2, and CR3 provide a capacitance and resistance that is equivalent to the resistance and capacitance of the inductor LM (referred to as DCR). Since Rdcr*Cdcr=L/DCR, where L is inductance of the inductor LM, the voltage level of the voltage VsenseM represents the average the inductor current RCM.

FIG. 7 illustrates one embodiment of a current sensing circuit 700, in accordance with some embodiments.

One, some, or all of the current sensing circuits 112S of the slave switching stages 102S can be provided in the same manner as the current sensing circuit 700, in accordance with some embodiments. The current sensing circuit 700 is connected to a switching node LNS of the relevant slave switching stage 102S. The ripple current RCS and the switching voltage VSWS are received by the current sensing circuit 700.

The current sensing circuit 700 includes a variable resistor RR, a resistor RSS, a capacitor CS1, a capacitor CS2, a capacitor CSC, a resistor RRHS, a capacitor CS3, and a voltage source configured to generate the voltage VBASE. The variable resistor RR is connected in series between a node VSWS and a node NS1. The capacitor CS2 is connected in series between a node NS1 and the resistor RRHS to make a high pass filter. As a result, the voltage at node NS2 is approximately equal to IL*LSS*DCRS/(RR*CS1)+VBASE. The parameter IL is the inductor current through the inductor LS, DCRS is DC resistance of the inductor LS has an inductance value of LSS. The resistor RRHS and the voltage source that generates VBASE are connected in series between a node NS2 and ground. The capacitor CS3 is connected in shunt to the node CS3. The capacitor CS1 is connected in series between the node NS1 and a node NS3. When there is a mismatch with the inductor LS of each of the slave switching stages 102S, the resistance value of the resistor RR is trimmed to ensure that the voltage VsenseS in all of switching stages 102 is close to the same load value.

The ACOTs 104S do not operate as a fixed switching frequency regulator. The resistors RRHS, RR, and RSS and the capacitors CSC, CS1, CS2, and CS3 provide a capacitance and resistance that is equivalent to the resistance and capacitance of the inductor LS (referred to as DCR) of the relevant slave switching stage 102S. Since Rdcr*Cdcr=LSS/DCR where LSS is inductance of the inductor LS, the voltage level of the voltage VsenseS represents the average the inductor current RCS of the relevant slave switching stage 102S.

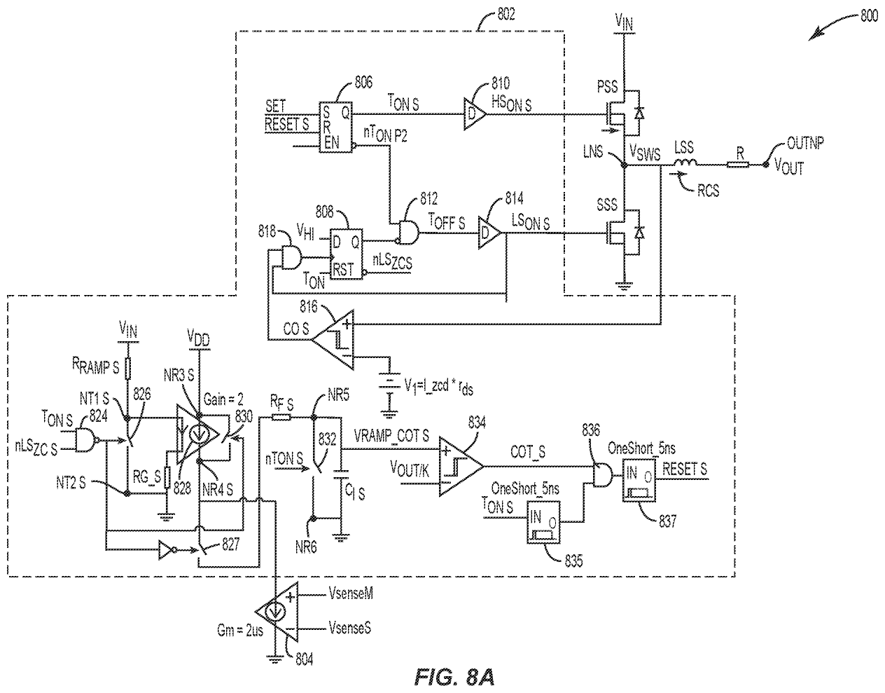

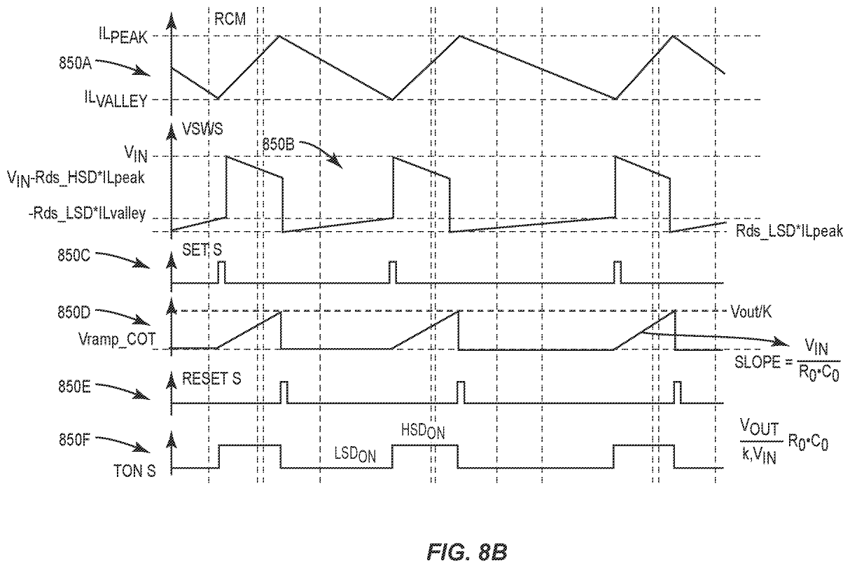

FIG. 8A is a circuit diagram of one embodiment of a slave switching stage 800, in accordance with some embodiments. FIG. 8B includes signal diagrams related to the slave switching stage 800, in accordance with some embodiments.

The slave switching stage 800 is an embodiment of the master switching stage 102M, in accordance with some embodiments. The slave switching stage 800 includes an ACOT controller 802 and a current balancing circuit 804. The ACOT controller 802 is an embodiment of an ACOT controller 104S of one of the slave switching stages 102S, in accordance with some embodiments. One, some, or all of the ACOT controllers 104S can be provided in the same manner as the ACOT controller 802. The current balancing circuit 804 is an example of one of the current balancing circuits 114S of one of the slave switching stages 102S. One, some, or all of the current balancing circuits 114S can be provided in the same manner as the current balancing circuit 804.

The slave switching stage 800 includes the primary slave switch PSS and the secondary slave switch SSS, which were discussed above with respect to FIG. 1. In this embodiment, the primary slave switch PSS is an NFET and the secondary slave switch SSS is an NFET. The primary slave switch PSS receives the DC input voltage Vin at the drain terminal. A source terminal of the primary slave switch PSS is connected to the drain terminal of the second slave switch SSS. The source terminal of the second slave switch SSS is connected to ground.

The ACOT controller 802 includes an SR latch 806. An S input terminal of the SR latch 806 is configured to receive a set signal SET S and an R input terminal of the SR latch 806 is configured to receive a reset signal RESET S. The set signal SET S corresponds to the slave switching stage 102S and is generated by a multi-phase controller 400. A clock terminal EN of the SR latch 806 is configured to receive an enable signal EN S. An output voltage TON S is generated by the SR latch 806 from a Q terminal of the SR latch 806. An output nTON_P2 (which is an inversion of the output TON S) is generated by the SR latch 806 from a Qn terminal.

The ACOT controller 802 includes a D latch 808. A D input terminal of the D latch 808 is configured to receive a voltage VHI. The voltage VHI has a constant voltage level set to the power source voltage level of a power source voltage VDD. A clock terminal of the D latch 808 is configured to receive a trigger signal TRG. An output voltage LSzc S is generated by the D latch 808 from a Q terminal of the D latch 808. An output nLSzc S (which is an inversion of the output LSzc S) is generated by the D latch 808 from a Qn terminal.

A delay gate 810 has an input terminal that receives the output voltage TON S generated by the SR latch 806 and generates an output voltage HSON. The delay gate 810 has a designed propagation delay. Thus, the output voltage HSON is a version of the output voltage TON S that is delayed by the propagation delay of the delay gate 810. The output voltage HSON is received by the gate of the primary slave switch PSS.

An AND gate 812 has one input terminal that receives the voltage nTON_P2 and another input terminal that receives the voltage LSzc S. The input terminal that receives the voltage LSzc S inverts the voltage LSzc S. The AND gate 812 is configured to generate a gate voltage LSON S that operates the low side master switch.

A delay gate 814 has an input terminal that receives the output voltage TOFF S generated by the SR latch 806 and generates a gate voltage LSDONLSON S. The delay gate 814 has a designed propagation delay. Thus, the gate voltage LSDONLSON S is a version of the output voltage TOFF that is delayed by the propagation delay of the delay gate 814. The gate voltage LSDONLSON S is received by the gate of the secondary slave switch SSS.

A voltage comparator 816 has a non-inverted terminal configured to receive the ramp signal Vramp and an inverted terminal that is configured to receive a voltage V1. Voltage V1 has a positive voltage level with a magnitude that is equal to I_zcd*rds. The voltage comparator 816 is configured to generate an output voltage CO S in a high voltage state in response to the ramp signal Vramp being higher than the voltage V1. The voltage comparator 816 is configured to generate the output voltage CO S in a low voltage state in response to the ramp signal Vramp being lower than the voltage V1.

An AND gate 818 has one input terminal that receives output voltage CO S and another input terminal that receives the voltage LSON S. The AND gate 818 is configured to generate an activation voltage AV. The activation voltage AV is configured to be received at the clock terminal of the D latch 808.

A NAND gate 824 has one input terminal that receives signal TON S and another input terminal that receives the voltage nLSzc S. The NAND gate 824 is configured to generate output voltage that opens and closes a switch 826.

A power source terminal is configured to receive the voltage VIN. A resistor Rramp S is connected in series between the power source terminal and a node NT1 S. The switch 826 is connected in series between the node NT1 S and a node NT2 S. The node NT2 S is connected to ground.

A transconductance amplifier 828 has an input terminal connected to the node NR1 S and another input terminal connected to a resistor RD. The resistor RD is connected in series between the input terminal of the transconductance amplifier 828 and the node NR2 S. A power source terminal is configured to receive the voltage VDD. A node NR3 2 is connected to the power source terminal that receives the voltage VDD. An output terminal of the transconductance amplifier 828 is connected to a node NR4 S. A switch 830 is connected in series in a bypass path (that bypasses the transconductance amplifier 828) between the node NR3 S and the node NR4 S. A switch 827 is connected in series between the node NR4 S and a first end of a resistor RF S. A second end of the resistor RF S is connected to a node NR5. A capacitor Ci S is connected in series between the node NR5 and a node NR6. The node NR6 is connected to ground. A switch 832 is connected in series in a bypass path (that bypasses the capacitor Ci S) between the node NR5 and the node NR6.

A voltage comparator 834 has a non-inverted terminal that is connected to the node NR5. A voltage VRAMP_COT S is generated at the node NR5 and is received by the non-inverted terminal that is connected to the node NR5. An inverted terminal of the voltage comparator 834 is configured to receive the DC output voltage Vout divided by a factor k. The factor k corresponds to the slave switching stage 102S such that the ripple current RCS has the same time period as the master ripple current RCM. An output voltage VCOT is generated by the voltage comparator 834. A oneshort generator 835 that has a narrow pulse is configured to receive the signal TON S. In this embodiment, the high voltage stage holding time of the oneshort generator 835 is designed by 5 ns. The oneshort generator 835 is configured to generate a narrow pulse version of the signal TON S that also is designed by 5 ns.

An AND gate 836 has one input terminal that is configured to receive the output voltage VCOT. Another input terminal of the AND gate 836 is configured to oneshort of TON_S signal A oneshort generator 837 is configured to generate a narrow pulse in the reset signal, which is the reset signal RESET S.

In this embodiment, the ramp generator 106 includes a circuit network that generates the ramp voltage VRAMP. As shown in FIG. 3A, the ramp generator 106 includes a voltage source that generates a voltage VBASE. A resistor RRHP is connected in series so as to receive the voltage VBASE at one end and is connected to a node NR1 S at the other end. In voltage diagram 8B, the voltage A capacitor CR2 is connected in series between the node NR1 S and a node NR2 S. A capacitor CR3 is connected in shunt at the node NR1 S. A resistor RR is connected in series between the node NR2 S and the non-inverting terminal of the voltage comparator 816. A capacitor CR1 is connected in series between the node NR2S and the node OUTNP.

Referring to FIG. 8A and FIG. 8B, FIG. 8B illustrates the operation of the ACOT controller 104M shown in FIG. 8A.

Signal diagram 850A illustrates the ripple current RCM generated across the inductor LM versus time, in accordance with some embodiments.

Signal diagram 850B illustrates the voltage VSWS at the node LNS, in accordance with some embodiments.

Signal diagram 850C illustrates the voltage SET S versus time, in accordance with some embodiments.

Signal diagram 850D illustrates the voltage VRAMP_COT S and the output voltage Vout divided by the factor k versus time, in accordance with some embodiments.

Signal diagram 850E illustrates the voltage RESET S and the output voltage Vout divided by the factor k versus time, in accordance with some embodiments.

Signal diagram 850F illustrates the voltage TON S versus time, in accordance with some embodiments. It should be noted that the voltage TOFF S is complementary and thus has a phase difference of 180 degrees with respect to TON S.

The ripple current RCS generated across the inductor LS oscillates between a current value of ILpeak to a current value of ILvalley. The primary switch PSS is turned on in order for the ripple current RCS to ramp up from the ILvalley. To do this, the multiphase controller 108 (see FIG. 4) is configured to provide the signal SET S, which corresponds to the appropriate one of the set signals SET_S3, SET S2, SET_S1 for the slave switching stage 102S, as explained above. As shown in voltage diagram 850C, the set signal SET S is switched from the low voltage state to the high voltage state. Assuming the enable signal EN S is in an active state and since the reset signal RESET S is in the low voltage state, the SR latch 806 generates the signal TON S in the high voltage state. Accordingly, after the propagation delay of the delay gate 810, the signal HSDON S is set to a high voltage state. In response, the primary slave switch PSS is closed (i.e., turned on). As a result, the ripple current RCS begins to ramp up and the switching voltage VSWS transitions to its peak value. Once the set signal SET S goes back into the low voltage state, the output signal TSON S is latched in the high voltage state. Thus, the primary slave switch PSS remains on.

When the signal TON S is in the high voltage state, the signal nTON S is in the low voltage state. Accordingly, the AND gate 812 outputs the signal TOFF S in the low voltage state. In response, the secondary slave switch SSS is opened (i.e., turned off). So long as the signal TON S remains in the high voltage state, the secondary slave switch SSS remains open.

The switch 826 and the switch 830 are open due to the output voltage nLSrzc being in a high voltage state and TON_S signal is high whereby the output voltage of the NAND gate 824 is in a high voltage state. Furthermore, the switch 827 is closed. Thus, a voltage is generated at the input terminals of the transconductance amplifier 830 that is based on the resistances of the resistors RRAMP S and RG_S (having a resistance value of ˜1Ω). Since the switch 832 is open since nTON S is in the low voltage state, a current is generated through the resistor RF S (having a resistance value equal to Gain*VIN/RRAMP_S) that charges the capacitor Ci S. As a result, the voltage VRAMP_COT S ramps up as shown in voltage diagram 800D in FIG. 8B. Eventually, the voltage VRAMP_COT S reaches and is greater than the voltage VOUT/k, which corresponds to the ripple current RCS having reached the peak current value of ILpeak. In this embodiment, the value of k is defined based on switching frequency of master converter and the same value in master title. In response, the comparator output voltage COT S is output in the high voltage state. Since TON S is in the high voltage state and the comparator output voltage COT S is in the high voltage state, the signal RESET S is output in the high voltage state. In response, the SR latch 806 is configured to output TON S in the low voltage state and output nTON S in the high voltage state.

In response, the primary slave switch PSS is opened and the ripple current RCS begins to ramp down towards the valley current value ILvalley. Furthermore, the switches 826, 830 are closed and the switch 827 is opened. Furthermore, the switch 832 is closed. As such, the node NR5 is shorted to ground causing the capacitor Ci S to be discharged. Consequently, the voltage VRAMP_COT S goes to ground and the signal RESET S goes back to the low voltage state.

However, note an embodiment of the current balancing circuit 114S is connected to the node NR4 S and thus to the transconductance amplifier 830. In this embodiment, the current balancing circuit 114S is another transconductance amplifier. A non-inverting terminal of the current balancing circuit 114S is configured to receive the voltage VsenseM while the inverting terminal of the current balancing circuit 114S is configured to receive the voltage VsenseS. When the average current levels of the current balancing circuit 114S adjust the transconductance, thereby changing the period of the ripple current RCS until the voltage VsenseM and the voltage VsenseS are approximately equal. For example, in response to the voltage VsenseM being greater than the voltage VsenseS, the current balancing circuit 114S decreases the transconductance such that it takes longer for VRAMP_COT_S to become equal to VOUT/k. This thereby increases the amount of time that it takes for RESET S to go to the high voltage state and thereby increases the time period which the ripple current RCS ramps up. In response to the voltage VsenseM being less than the voltage VsenseS, the current balancing circuit 114S increases the transconductance such that it takes less time for VRAMP_COT_S to become equal to VOUT/k. This thereby decreases the amount of time that it takes for RESET S to go to the high voltage state and thereby decreases the time period which the ripple current RCS ramp up.

The SR latch 806 has now latched so that TON S is in the low voltage state and that nTON S is in the high voltage state. Once the voltage VSWS is above the voltage V1, the comparator 816 is configured to generate the comparator output voltage CO S in the high voltage state.

The reset terminal RST of the D latch 808 is configured to receive TON. In response to the output TON being in the low voltage state, the D latch 808 receives the low voltage state at the reset terminal RST and is configured to output LSZC in the low voltage state. The inverted terminal of the AND gate 812 is thus configured to receive the inversion of LSZC, which is in the high voltage state. Accordingly, both of the input terminals of the AND gate 812 are now in the high voltage state. This results in the output TOFF of the AND gate 812 being in the high voltage state and thus the output LSDON of the delay gate 814 is in the high voltage state. Accordingly, the secondary master switch SSM is turned on in response to the LSDON being in the high voltage state.

Once the voltage VRAMP is above the voltage V1, the comparator 816 is configured to generate the comparator output CO in the high voltage state. As such both input terminals of the AND gate 818 are both in the high voltage state, since both LSDON state and the comparator output CO are in the high voltage state. In response, the output AV of the AND gate 818 is generated in the high voltage state, resulting in the D latch 808 receiving the high voltage state. The voltage VHI is a DC voltage in the high voltage state that is received at the D terminal of the D latch 808. Accordingly, in response to the output AV being in the high voltage state, the output LSZC of the D latch 808 is in the high voltage state. This results in the inverted terminal of the AND gate 812 receiving the low voltage state. In response, the output of the AND gate TOFF is in the low voltage state and, in response, the output LSDON of the delay gate 814 is in the low voltage state. This results in the master secondary switch SSM again being opened (i.e., turned off). The cycle thus can again begin and repeat itself in the next oscillation.

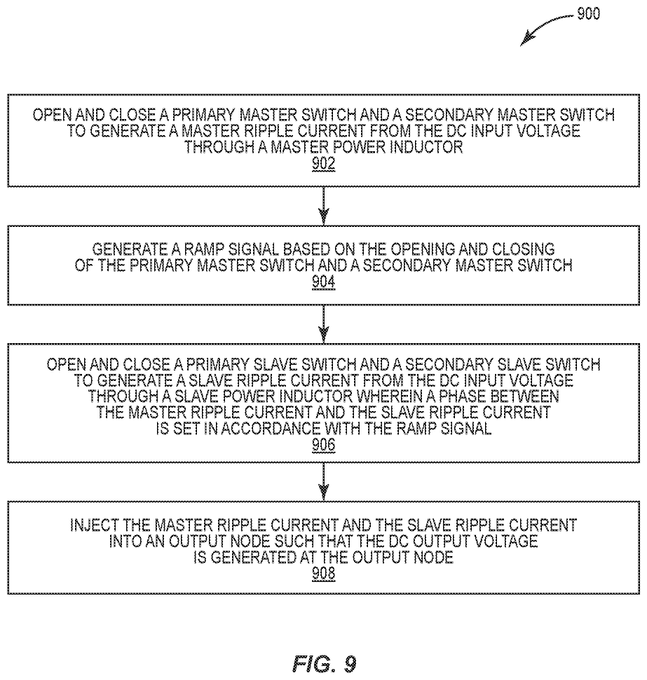

FIG. 9 is a flow diagram 900 of a method of converting a DC input voltage into a DC output voltage, in accordance with some embodiments.

The flow diagram 900 includes blocks 902-908. Flow begins at block 902. At block 902, a primary master and a secondary master switches are opened and closed, respectively, to generate a master ripple current from the DC input voltage through a master power inductor. An example of the DC input voltage is the DC input voltage Vin in FIG. 1, in accordance with some embodiments. An example of the primary master switch is the primary master switch PSM in FIG. 1, in accordance with some embodiments. An example of the secondary master switch is the secondary master switch SSM in FIG. 1, in accordance with some embodiments. An example of the master ripple current is the master ripple current RCM in FIG. 1, in accordance with some embodiments. An example of the master power inductor is the master power inductor LM in FIG. 1, in accordance with some embodiments. Flow then proceeds to block 904.

At block 904, a ramp signal is generated based on the opening and closing of the primary master switch and the secondary master switch, respectively. An example of the ramp signal is the ramp signal VRAMP_PH in FIG. 4, in accordance with some embodiments. Flow then proceeds to block 906.

At block 906, a primary slave switch and a secondary slave switch are opened and closed to generate a slave ripple current from the DC input voltage through a slave power inductor wherein a phase between the master ripple current and the slave ripple current is set in accordance with the ramp signal. An example of the primary slave switch is the primary slave switch PSS in FIG. 1, in accordance with some embodiments. An example of the secondary slave switch is the secondary master switch SSS in FIG. 1, in accordance with some embodiments. An example of the slave ripple current is the slave ripple current RCS in FIG. 1, in accordance with some embodiments. An example of the slave power inductor is the slave power inductor LS in FIG. 1, in accordance with some embodiments. Flow then proceeds to block 908.

At block 908, the master ripple current and the slave ripple current are injected into an output node such that the DC output voltage is generated at the output node. An example of the output node is the output node OUTNP in FIG. 1. An example of the DC output voltage is the DC output voltage VOUT in FIG. 1, in accordance with some embodiments.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A switch converter, comprising:
a master switching stage comprising a master primary switch, a master secondary switch, a master power inductor, a master controller wherein the master switching stage is operable to receive a Direct Current (DC) input voltage and wherein the master controller is configured to:
open and close the master primary switch and the master secondary switch to generate a master ripple current from the DC input voltage through the master power inductor; and
generate a ramp signal based on the opening and closing of the master primary switch and the master secondary switch; and
a slave switching stage comprising a slave primary switch, a slave secondary switch, a slave power inductor, a slave controller wherein the slave switching stage is operable to receive the DC input voltage and wherein the slave controller is configured to:
receive the ramp signal; and
open and close the slave primary switch and the slave secondary switch to generate a slave ripple current from the DC input voltage through the slave power inductor wherein a phase between the master ripple current and the slave ripple current is set in accordance with the ramp signal.

2. The switch converter of claim 1, wherein:
the master power inductor and the slave power inductor are coupled to inject the master ripple current and the slave ripple current into an output node, wherein a DC output voltage is generated at the output node.

3. The switch converter of claim 2, wherein a power capacitor is coupled in shunt to the output node.

4. A switch converter, comprising:
a master switching stage comprising a master primary switch, a master secondary switch, and a master power inductor, wherein the master switching stage is operable to receive a Direct Current (DC) input voltage and wherein a master controller is configured to:
open and close the master primary switch and the master secondary switch to generate a master ripple current from the DC input voltage through the master power inductor; and
generate a ramp signal based on the opening and closing of the master primary switch and the master secondary switch; and
slave switching stages, each of the slave switching stages is configured to:
receive the ramp signal; and
generate a slave ripple current from the DC input voltage;
wherein the slave switching stages are configured such that a phase of each of the slave ripple currents of the slave switching stages is set based on a different reference level of the ramp signal.

5. The switch converter of claim 4, wherein:
the master switching stage and the slave switching stages are coupled to inject the master ripple current and the slave ripple currents into an output node, wherein a DC output voltage is generated at the output node.

6. The switch converter of claim 5, wherein a power capacitor is coupled in shunt to the output node.

7. A method of converting a DC input voltage into a DC output voltage, comprising:
opening and closing a primary master switch and a secondary master switch to generate a master ripple current from the DC input voltage through a master power inductor;
generating a ramp signal based on the opening and closing of the primary master switch and the secondary master switch;
opening and closing a primary slave switch and a secondary slave switch to generate a slave ripple current from the DC input voltage through a slave power inductor wherein a phase between the master ripple current and the slave ripple current is set in accordance with the ramp signal; and
injecting the master ripple current and the slave ripple current into an output node such that the DC output voltage is generated at the output node.
